(19) United States
(12) Patent Application Publication
(10) Pub. No.: US 2020/0050785 A1
(43) Pub. Date: Feb. 13, 2020

(54) DATABASE RECORD ACCESS THROUGH USE OF A MULTI-VALUE ALTERNATE PRIMARY KEY

(71) Applicant: CA, Inc., New York, NY (US)

(72) Inventors: Frederic Duminy, St. Charles, IL (US); David Pflum, Elmhurst, IL (US); Timothy Dockter, Elgin, IL (US); James W. Peters, West Chicago, IL (US); John C. Pinkowski, Carol Stream, IL (US)

(21) Appl. No.: 16/100,924

(22) Filed: Aug. 10, 2018

(51) Int. Cl. G06F 21/62; G06F 17/30

(52) U.S. Cl. CPC G06F 21/6227; G06F 17/3033; G06F 17/30595; G06F 17/30433

(57) ABSTRACT

A method includes performing by a host system processor: receiving a record insert request for a database, the record insert request comprising a primary key value and a semi-unique key value, the database comprising a record structure comprising a first primary key field, a second primary key field, and a semi-unique key field, the first primary key field comprising a flag portion for which a first flag value is indicative of the first primary key field containing a primary key and a second flag value is indicative of the first primary key field containing an alternate primary key, generating an alternate primary key value based on the primary key value and the semi-unique key value, the alternate primary key value having a portion thereof corresponding to the flag portion of the first primary key field set to the second flag value, generating a record comprising the alternate primary key value in the first primary key field, the primary key value in the second primary key field, and the semi-unique key value in the semi-unique key field, and communicating the record to the database.

### BACKGROUND

The present disclosure relates to computer systems, and, in particular, to methods, systems, and computer program products for managing information in a computer database.

Computer database management systems (DBMS) may provide utilities for extracting portions of data that are stored in a database for use by other applications or devices. For example, DB2 is a relational database management system (RDBMS) that provides various utilities for performing operations on one or more source objects, such as a table. These operations are often performed based on keys, which ensure each record within a table can be uniquely identified by one or a combination of fields within the table. A primary key is typically chosen as one or more fields that are most appropriate to be the main reference key for the table. The primary key must contain unique values, must never be null, and must uniquely identify each record in the table. A pre-existing database may use a primary key with a fixed length. There may be circumstances, however, where it is desirable to provide additional granularity for record retrieval beyond that provided by the primary key. For example, a primary key may be based on an eight character naming convention, which means the primary key field may be defined as being eight bytes wide. It may be desirable to further subdivide records identifiable by the primary key based on sub-categories that can be defined using four characters, which takes up four bytes. Expanding the primary key from eight bytes to twelve bytes, however, would necessitate a redesign of the existing database and tables therein and may also involve the creation of dual code paths in application software where legacy code continues use of the eight byte primary key while new code makes use of the new expanded primary key.

### SUMMARY

In some embodiments of the inventive subject matter, a method comprises, performing by a host system processor: receiving a record insert request for a database, the record insert request comprising a primary key value and a semi-unique key value, the database comprising a record structure comprising a first primary key field, a second primary key field, and a semi-unique key field, the first primary key field comprising a flag portion for which a first flag value is indicative of the first primary key field containing a primary key and a second flag value is indicative of the first primary key field containing an alternate primary key, generating an alternate primary key value based on the primary key value and the semi-unique key value, the alternate primary key value having a portion thereof corresponding to the flag portion of the first primary key field set to the second flag value, generating a record comprising the alternate primary key value in the first primary key field, the primary key value in the second primary key field, and the semi-unique key value in the semi-unique key field, and communicating the record to the database.

In other embodiments of the inventive subject matter, a method comprises, performing by a host system processor: receiving a record retrieve request for a database, the record retrieve request comprising an alternate primary key value, which is based on a primary key value and a semi-unique key value, the database comprising a record structure comprising a first primary key field, a second primary key field, and a semi-unique key field, the first primary key field comprising a flag portion for which a first flag value is indicative of the first primary key field containing a primary key and a second flag value is indicative of the first primary key field containing an alternate primary key, the alternate primary key value having a portion thereof corresponding to the flag portion of the first primary key field set to the second flag value, the record for which the retrieve request is received comprising the primary key value in the second primary key field and the semi-unique key value in the semi-unique key field, communicating the alternate primary key value to the database, receiving from the database a plurality of records for which the respective flag portions of the first primary key field are set to the second flag value, performing for each of the plurality of records received from the database: generating a candidate primary key value, wherein generating the candidate primary key value comprises performing a logic operation on a semi-unique key field value and the alternate primary key value, comparing the candidate primary key value with a second primary key field value, and determining that one of the plurality of records corresponds to the record for which the retrieve request is received when the candidate primary key value matches the second primary key field value.

In further embodiments of the inventive subject matter, a system comprises a processor and a memory coupled to the processor. The memory comprises computer readable program code embodied in the memory that is executable by the processor to perform operations comprising: receiving a record insert request for a database, the record insert request comprising a primary key value, a semi-unique key value, and a secondary key value, the database comprising a record structure comprising a first primary key field, a second primary key field, and a semi-unique key field, the first primary key field comprising a flag portion for which a first flag value is indicative of the first primary key field containing a primary key and a second flag value is indicative of the first primary key field containing an alternate primary key, generating an alternate primary key value based on the primary key value, the semi-unique key value, and the secondary key value, the alternate primary key value having a portion thereof corresponding to the flag portion of the first primary key field set to the second flag value, generating a record comprising the alternate primary key value in the first primary key field, the primary key value in the second primary key field, and the semi-unique key value in the semi-unique key field, and communicating the record to the database

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including various host systems that communicate with a database management system server for accessing database records through use of a multi-value alternate primary key in accordance with some embodiments of the inventive subject matter;

FIG. 2 illustrates a data processing system that may be used to implement the host systems of FIG. 1 in accordance with some embodiments of the inventive subject matter;

FIG. 3 is a block diagram that illustrates a software/hardware architecture for use in an a host system for accessing database records through use of a multi-value alternate primary key in accordance with some embodiments of the inventive subject matter;

FIGS. 4 and 5 are flowchart diagrams that illustrate operations for accessing database records through use of a multi-value alternate primary key in accordance with some embodiments of the inventive subject matter;

FIGS. 6A-6C are diagrams that illustrate logical operations for generating an alternate primary key value in accordance with some embodiments of the inventive subject matter; and

FIG. 7 is a block diagram that illustrates an example field design for records in a database in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it is not limited to, a hardware element, firmware component, and/or software component. A data processing system may be configured with one or more data processing facilities.

Embodiments of the inventive subject matter are described herein in the context of inserting and retrieving data to and from a relational database, such as a DB2 database. It will be understood that embodiments of the inventive subject matter are not limited in their application to a relational database model as other database models, such as, but not limited to a flat database model, a hierarchical database model, a network database model, an object-relational database model, and a star schema database model may also be used.

A legacy database may use a primary key field design in which one or more bits aren't used based on the range of primary key values. Some embodiments of the inventive subject matter stem from a realization that these unused bit(s) in the primary key field may be used as a flag that can signify whether a primary key value is stored in the primary key field or an alternate primary key value is stored in the primary key field. The alternate primary key value may be generated by logically combining a primary key value with other values, such as a semi-unique key value to ensure the flag portion bit(s) are set properly to identify the value as an alternate primary key value, and other secondary key values that may be representative of other attributes for the record to provide greater granularity than may be provided by the primary key alone. Two additional fields may be added to the database to store the original primary key value and the semi-unique key value. In some embodiments, new fields may also be added to the database for the secondary key values. When retrieving records from the database, an application communicates an alternate primary key value to a database, e.g., a database management system, which recognizes that the key value is an alternate primary key value. The records for which an alternate primary key value is stored in the primary key field are returned to the application, which then processes the retrieved records as follows: The records are read one at a time and the semi-unique key value is retrieved from the respective record. The semi-unique key value is logically combined with the alternate primary key value and the result may, in some embodiments, be logically combined with any secondary key values to obtain a primary key value. The primary key value is then compared with the primary key value stored in the second primary key field from the record to determine if there is a match. If a match is obtained, then the operations stop and the record is determined to correspond to the alternate primary key value. If a match is not obtained, then the operations repeat for the next record. Thus, embodiments of the inventive subject matter provide a mechanism for encoding one or more secondary key values into an alternate primary key value without the need to expand the primary key field of a legacy database. These secondary key values may correspond to parameters or categories to provide additional granularity for the records in the database. Because the primary key field may remain the same size, a conversion of the database to accommodate a new primary key size may be avoided and application software may maintain the same control block structures without the need to develop dual code paths—one path for the legacy primary key and another path for a new primary key having an increased size to accommodate greater granularity in distinguishing between records.

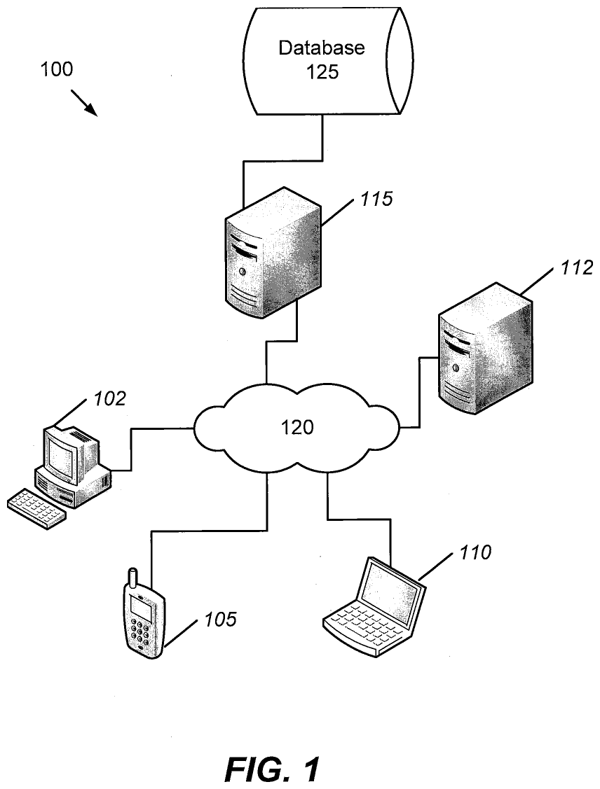

Referring to FIG. 1, a communication network including various host systems that communicate with a database management system server for accessing database records through use of a multi-value alternate primary key, in accordance with some embodiments of the inventive subject matter, comprises client devices 102, 105, and 110 along with an application server 112 that are coupled to a database management system server 115 via a network 120. The network 120 may be a global network, such as the Internet or other publicly accessible network. Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks. The client devices 102, 105, 110 may represent wired and/or wireless devices that include one or more applications that use data records that may allow a user to interact and perform transactions on the database 125 via the database system server 115. The application server 112 may likewise represent a server, mainframe, enterprise computing system, or other data processing system that may allow one or more users to interact and perform transactions on the database 125. The client devices 102, 105, 110 and the application server 112 that are configured to support an application for performing transactions on the database 125 by way of the database system server 115 may be referred to as host system processors. The client devices or terminals 102, 105, 110 and application server 112 may be connected directly to the database management system server 115 without going through the network 120 in other embodiments of the inventive subject matter. It will be appreciated that in accordance with various embodiments of the inventive subject matter, the client devices or terminals 102, 105, 110, application server 112, and database system management server 115 may be implemented as single processor systems, multi-processor systems, single server systems, separate server systems, or a network of servers either co-located in a server farm, for example, or located in different geographic regions.

As shown in FIG. 1, some embodiments according to the inventive subject matter can operate in a logically separated client side/server side-computing environment, sometimes referred to hereinafter as a client/server environment. The client/server environment is a computational architecture that involves a client process (i.e., client devices/systems 102, 105, 110, and 112) requesting service from a server process (i.e., database management system server 115). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

The clients and servers can communicate using a standard communications mode, such as Hypertext Transport Protocol (HTTP), SOAP, XML-RPC, and/or WSDL. According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

Although FIG. 1 illustrates an example communication network including various host systems that communicate with a database management system server for accessing database records through use of a multi-value alternate primary key, it will be understood that embodiments of the inventive subject matter are not limited to such configurations, but are intended to encompass any configuration capable of carrying out the operations described herein.

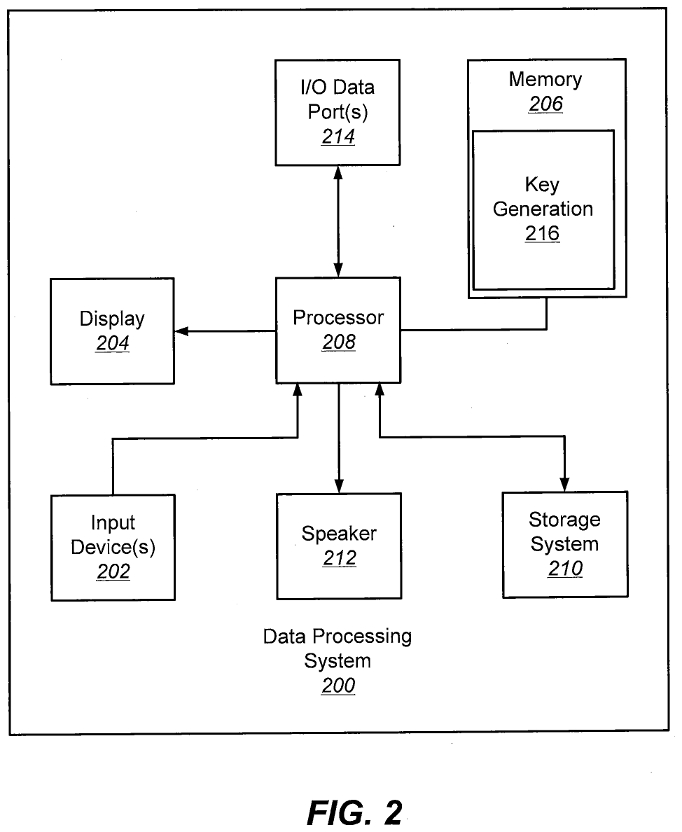

Referring now to FIG. 2, a data processing system 200 that may be used to implement the client devices or terminals 102, 105, 110, application server 112, and/or the database management system server 115 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a key generation/decoding module 216 that may provide functionality that may include, but is not limited to, accessing database records through use of a multi-value alternate primary key in accordance with some embodiments of the inventive subject matter.

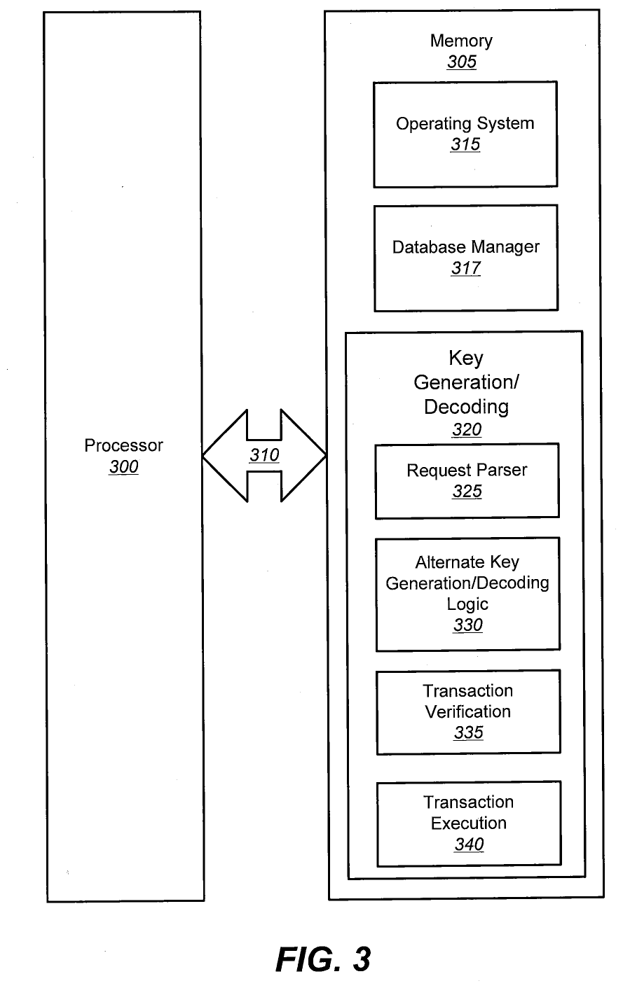

FIG. 3 illustrates a processor 300 and memory 305 that may be used in embodiments of data processing systems, such as the client devices or terminals 102, 105, 110, application server 112, and the database management system server 115 of FIG. 1 and the data processing system 200 of FIG. 2, respectively, for accessing database records through use of a multi-value alternate primary key in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for accessing database records through use of a multi-value alternate primary key in accordance with some embodiments of the inventive subject matter. It will be understood that the memory 305 may, in some embodiments, be equipped with only some of the modules described herein based on whether the processor 300 and memory 305 are in one of the client devices or terminals 102, 105, 110, and application server 112, or whether the processor 300 and memory 305 is in the database management system server 115. The modules included in the memory 305 may also be dependent on the division of functionality between the host system processors (e.g., the client devices or terminals 102, 105, 110, and application server 112) and the database management system server 115. The memory 305 may include, but is not limited to, the following types of devices: cache, ROM, PROM, EPROM, EEPROM, flash, SRAM, and DRAM.

As shown in FIG. 3, the memory 305 may contain three or more categories of software and/or data: an operating system 315, a database manager 317, and a key generation/decoding module 320. In particular, the operating system 315 may manage the data processing system's software and/or hardware resources and may coordinate execution of programs by the processor 300. The database manager 317 may comprise the database management system (DBMS) software, which is used to facilitate the definition, creation, querying, update, and administration of the database 125. The key generation/decoding module 320 may comprise a request parser module 325, an alternate key generation/decoding logic module 330, a transaction verification module 335, and a transaction execution module 340.

The request parser module 325 may be configured to receive a record transaction request for the database 125, e.g., a record insert request or a record retrieve request, and to parse the request to obtain the field information to support the requested transaction. For example, in the case of a record insert request, a primary key value and a semi-unique key value may be provided in the request along with one or more secondary key values that are used to provide additional record granularity beyond that provided by the primary key field. In the case of a record retrieve request, an alternate primary key value may be provided, which is based on a primary key value, a semi-unique key value, and one or more secondary key values.

The alternate key generation/decoding logic module 330 may be configured to generate the alternate primary key value by logically combining a primary key value with other values, such as a semi-unique key value and one or more other secondary key values. As both primary key values and alternate primary key values are stored in the primary key field in the database 125, one or more bits of the primary key field may be defined as a flag portion and may be used to distinguish between primary key values and alternate primary key values. Thus, the semi-unique key value may be selected to ensure the flag portion bit(s) are set properly to identify the value as an alternate primary key value. The secondary key values may be representative of other attributes for the record to provide greater granularity than may be provided by the primary key alone. Two additional fields may be added to the database 125 to store the original primary key value and the semi-unique key value. In some embodiments, new fields may also be added to the database 125 for the secondary key values. When retrieving records from the database 125, an application communicates an alternate primary key value to the database 125, e.g., a database management system 115, which recognizes that the key value is an alternate primary key value. The records for which an alternate primary key value is stored in the primary key field are returned to the application, which then processes the retrieved records. The alternate key generation/decoding logic module 330 may use the semi-unique key values from the respective records and, for each record processed, logically combine the semi-unique key value with the alternate primary key value to obtain a result. The result may, in some embodiments, be logically combined with any secondary key values to obtain a primary key value. The primary key value output from the logic operation may be provided to the transaction verification module 335 for further processing as described below.

The transaction verification module 335 may be configured to process records obtained from the database 125 in response to a record retrieve request to confirm that the retrieve request complete successfully. In the case of a record retrieve request using an alternate primary key, the transaction verification module 335 cooperates with the alternate key generation/decoding logic module 330 to cycle through the retrieved records that contain alternate primary key values in the primary key field to obtain the primary key value based on logic operations applied to the provided alternate primary key value, semi-unique key value read from the respective record, and any secondary key values. The primary key value resulting from the logic operations is compared to the primary key value stored in a second primary key field from the record. If there is a match, then the record may be determined to correspond to the alternate primary key value provided by the application. If the comparison fails to result in a match, then the next retrieved record is processed until a match is obtained.

The transaction execution module 340 may be configured to construct a record for insertion into the database 125. For example, in the case of inserting a record using an alternate primary key value, the transaction execution module 340 may cooperate with the alternate key generation/decoding logic module 330 to generate the alternate primary key value based on the primary key value, the semi-unique key value, and, in some embodiments, one or more secondary key values. The record may be constructed with the alternate primary key value in the primary key field, the primary key value in a second primary key field, and the semi-unique key value in a semi-unique key field. In some embodiments, one or more fields may be defined for storing one or more secondary key values, respectively, in the record. The record is then communicated to the database 125 for insertion therein by way of the database management system 115. In the case of requesting a record based on an alternate primary key value from the database 125, the transaction execution module 340 may be configured to communicate the alternate primary key value to the database management system 115, which recognizes the value as an alternate primary key value based on the value (i.e., bit settings) of the flag portion. The database management system 115 retrieves the records corresponding to alternate primary key values and returns them to the requesting application.

Although FIG. 3 illustrates hardware/software architectures that may be used in data processing systems, such as the client devices or terminals 102, 105, 110, application server 112, and database management system server 115 of FIG. 1 and the data processing system 200 of FIG. 2, respectively, for accessing database records through use of a multi-value alternate primary key in accordance with some embodiments of the inventive subject matter, it will be understood that embodiments of the present invention are not limited to such a configuration but is intended to encompass any configuration capable of carrying out operations described herein.

Computer program code for carrying out operations of data processing systems discussed above with respect to FIGS. 1-3 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the client devices or terminals 102, 105, 110, application server 112, and database management system server 115 of FIG. 1, the data processing system 200 of FIG. 2, and the hardware/software architecture of FIG. 3, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

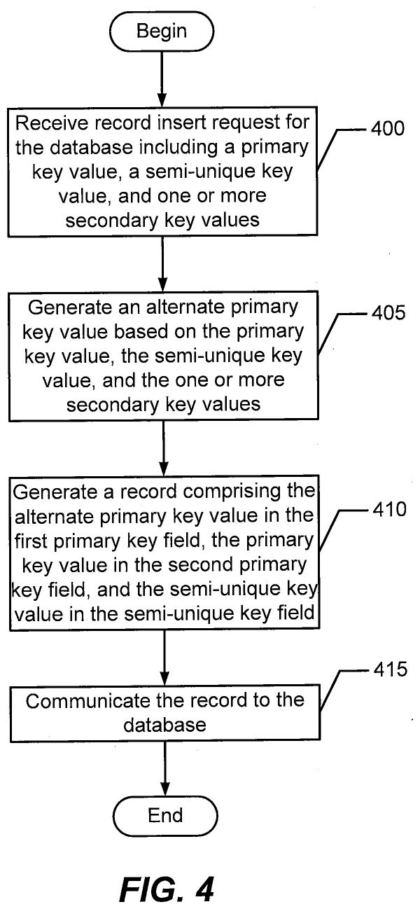

The data processing apparatus of FIGS. 1-3 may be used to facilitate the access of database records through use of a multi-value alternate primary key according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 206 coupled to the processor 208 and the memory 305 coupled to the processor 300 include computer readable program code that, when executed by the respective processors, causes the respective processors to perform operations including one or more of the operations described herein with respect to FIGS. 4, 5, 6A-6C, and 7.

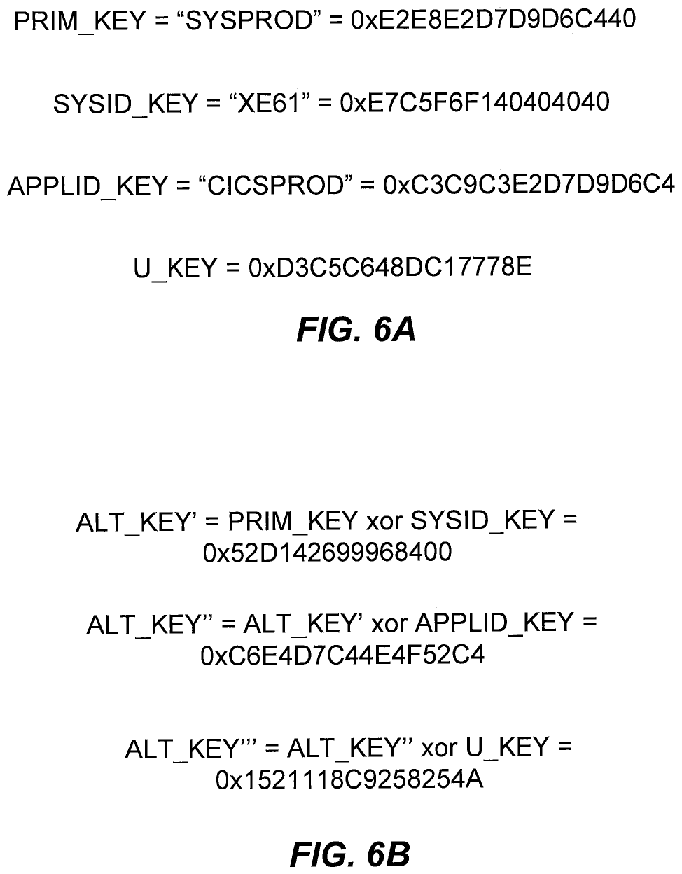

FIG. 4 is a flowchart diagram that illustrates operations for inserting a database record into a database through use of a multi-value alternate primary key in accordance with some embodiments of the inventive subject matter. Operations begin at block 400 where one of the host systems (e.g., the client devices or terminals 102, 105, 110, and application server 112) receives a record insert request for the database by way of an application running thereon. The record insert request may include a primary key value, a semi-unique key value, and one or more secondary key values. This is illustrated, for example, in FIG. 6A, which shows a primary key (PRIM_KEY) value of “SYSPROD,” a semi-unique key (U_KEY) value of 0xD3C5C648DC17778E, and two secondary keys: a system identification key (SYSID_KEY) value of “XE61” and an application identification key (APPLID_KEY) value of “CICSPROD.” Thus, in the example of FIG. 6A, embodiments of the inventive subject matter may allow for the insertion and retrieval of records in a database that contains records for a production computer system (SYSPROD) that have greater granularity with respect to an affinity towards particular system identifications (SYSID) and application identifications (APPLID). In some embodiments the semi-unique key may be generated based on a local system clock timestamp.

Returning to FIG. 4, operations continue at block 405 where an alternate primary key value is generated based on the primary key value, the semi-unique key value, and the one or more secondary key values. In some embodiments, the alternate primary key value may be generated by performing exclusive or operations on the primary key value, the semi-unique key value, and the one or more secondary key values. This is illustrated, for example, in FIG. 6B, which illustrates the alternate primary key value ALT_KEY′″ being generated through a series of exclusive or operations of PRIM_KEY with SYSID_KEY to generate ALT_KEY′, then ALT_KEY′ with APPLID_KEY to generate ALT_KEY″, and then ALT_KEY″ with U_KEY to generate ALT_KEY′″. The semi-unique key value may be generated to ensure that the flag portion of the alternate primary key value has a value that indicates the alternate primary key value corresponds to an alternate primary key as opposed to primary key. This allows both alternate primary key values and primary key values to be stored in the primary key field in the database records. In the example of FIG. 6A and FIG. 6B, the two least significant bits of the primary key field may be used as the flag portion and a value of 10 may indicate that the value is an alternate primary key value and a value of 00 may indicate that the value is a primary key value. At block 410, a record is generated in which the alternate primary key value is in a first primary key field (e.g., the primary key field currently used in the legacy database), the primary key value is in a second primary key field, which may be a new field added to the database records, and the semi-unique key value is in the semi-unique key field, which may also be a new field added to the database records. In some embodiments, the one or more secondary key values may also be added to respective fields making up the record. At block 415, the record is communicated to a database, such as the database 125, by way of the database management system 115.

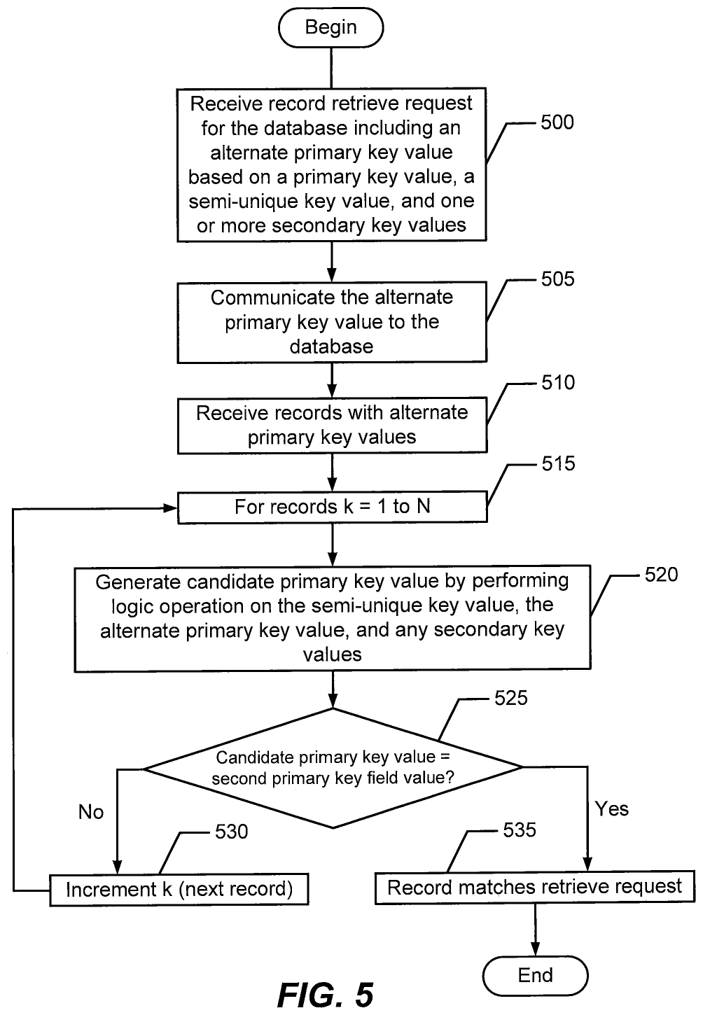

FIG. 5 is a flowchart diagram that illustrates operations for retrieving a database record from a database through use of a multi-value alternate primary key in accordance with some embodiments of the inventive subject matter. Operations begin at block 500 where one of the host systems (e.g., the client devices or terminals 102, 105, 110, and application server 112) receives a record retrieve request for the database by way of an application running thereon. The record retrieve request may include an alternate primary key value, which is based on a primary key value, a semi-unique key value, and one or more secondary key values as described above with respect to FIGS. 4, 6A, and 6B. The alternate primary key value may be communicated to the database 125 by way of the database management system 115 at block 505. The database management system 115 may determine that the primary key value provided by the host system is an alternate primary key value based on the value in the flag portion of the field. In the example of FIG. 6B, the alternate primary key value (ALT_KEY′″) has its two least significant bits set to 10, which indicates the value is an alternate primary key value. Thus, the database management system 115 retrieves the records having alternate primary key values in the legacy primary key field (e.g., first primary key field) and provides these records to the host system at block 510. The host system application processes the received records beginning at block 515. Assuming that N records are retrieved that have alternate primary key values in the first primary key field, a candidate primary key value is generated at block 520 by performing logic operations on the alternate primary key value, the semi-unique key value, and any secondary key values. The semi-unique key value is obtained from the record while the secondary key values may, in some embodiments, be obtained from the record or, in other embodiments, be provided by the host application. These logic operations are illustrated, for example, in FIG. 6C, which continues the example of FIGS. 6A and 6B. Referring now to FIG. 6C, the alternate primary key value ALT_KEY′″ is logically combined with the semi-unique key U_KEY value through an exclusive or operation to generate ALT_KEY″. An exclusive or operation is applied to ALT_KEY″ and the secondary key APPLID_KEY value (CICSPROD) to obtain ALT_KEY′. Another exclusive or operation is applied to ALT_KEY′ and the secondary key SYSID_KEY value (XE61) to obtain the original primary key PRIM_KEY value (SYSPROD).

Returning to FIG. 5, a determination is made at block 525 whether the candidate primary key value matches the value in the second primary key field from the record, which is where the original primary key value on which the alternate primary key value is based is stored. If there is a match, such as the example described above with respect to FIG. 6C, then a determination is made at block 535 that the record has been found that matches the retrieve request and the processing of the retrieved records corresponding to alternate primary key values can cease. If, however, the candidate primary key value and the second primary key field value from the record do not match, then operations continue at block 530 where the record loop counter is incremented and a candidate primary key value is generated for the next record at block 520.

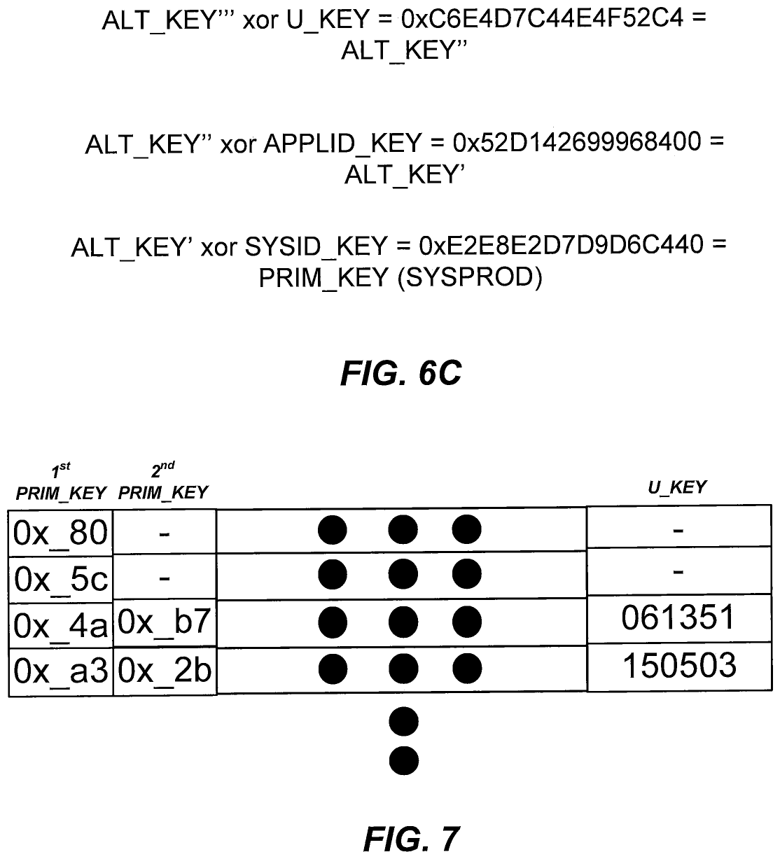

FIG. 7 is a block diagram that illustrates an example field design for records in a database in accordance with some embodiments of the inventive subject matter. As shown in FIG. 7, the 1^{st} PRIM_KEY field may correspond to the legacy primary key field for the database. The 2^{nd} PRIM_KEY field may be a field that has been added for storing the original primary key value for a record to be accessed using an alternate primary key value. In the FIG. 7 example, the first two records are records accessible directly via a primary key value and do not have an entry in the 2^{nd} PRIM_KEY field. The third and fourth records are associated with alternate primary key values, which are indicated by their least significant bits being 10. Accordingly, the primary key values from which these alternate primary key values have been generated are stored in the 2^{nd} PRIM_KEY field. In addition, a U_KEY field is added for storing the semi-unique key value used in generating the alternate primary key value.

Embodiments of the inventive subject matter may allow for improved record granularity in a legacy database without the need for expanding the size of the primary key field used to access the database. This is a result of encoding information associated with one or more additional criteria (e.g., secondary field information) into an alternate primary key value having a same size as the primary key. As a result, the number of records accessible in the database may be increased based on the original primary key size. Because the key size and structure remains the same, this may also obviate the need for dual code paths in application software to support the legacy primary key and an expanded primary key providing the additional granularity. Moreover, the additional criteria (e.g., secondary field values) encoded into the alternate primary key value may allow the records to have a particular affinity one or more narrower classifications than can be specified solely based on the original primary key. For example, a database may use a primary key that specifies a geographic location by state. A secondary field may be defined that further specifies city, town, or municipality. The secondary field value may be logically combined with the primary key field value to generate an alternate primary key value having the same size as the primary key field value, but allowing access to a record that has an affinity for a particular geographic location based not solely on state, but state and city, for example.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

What is claimed is:

1. A method comprising:
performing by a host system processor:
receiving a record insert request for a database, the record insert request comprising a primary key value and a semi-unique key value, the database comprising a record structure comprising a first primary key field, a second primary key field, and a semi-unique key field, the first primary key field comprising a flag portion for which a first flag value is indicative of the first primary key field containing a primary key and a second flag value is indicative of the first primary key field containing an alternate primary key;
generating an alternate primary key value based on the primary key value and the semi-unique key value, the alternate primary key value having a portion thereof corresponding to the flag portion of the first primary key field set to the second flag value;
generating a record comprising the alternate primary key value in the first primary key field, the primary key value in the second primary key field, and the semi-unique key value in the semi-unique key field; and
communicating the record to the database.

2. The method of claim 1, wherein the record structure of the database further comprises a secondary key field;
wherein the record insert request further comprises a secondary key value;
wherein generating the alternate primary key value comprises:
generating the alternate primary key value based on the primary key value, the semi-unique key value, and the secondary key value; and
wherein generating the record further comprises:
generating the record comprising the secondary key value in the secondary key field.

3. The method of claim 2, wherein generating the alternate primary key value comprises performing a logic operation on the primary key value, the semi-unique key value, and the secondary key value.

4. The method of claim 3, wherein the logic operation is an exclusive or logic operation.

5. The method of claim 2, wherein the secondary key value comprises computer system identification information.

6. The method of claim 2, wherein the secondary key value comprises application identification information.

7. The method of claim 1, wherein the record structure of the database further comprises a plurality of secondary key fields;
wherein the record insert request further comprises a plurality of secondary key values;
wherein generating the alternate primary key value comprises:
generating the alternate primary key value based on the primary key value, the semi-unique key value, and the plurality of secondary key values; and
wherein generating the record further comprises:
generating the record comprising the plurality of secondary key values in the plurality of secondary key fields, respectively.

8. The method of claim 7, wherein generating the alternate primary key value comprises performing a logic operation on the primary key value, the semi-unique key value, and the plurality of secondary key values.

9. The method of claim 1, wherein the semi-unique key value comprises host system clock information.

10. The method of claim 1, wherein the database is a relational database.

11. The method of claim 10, wherein the relational database is a DB2 database.

12. A method comprising:
performing by a host system processor:
receiving a record retrieve request for a database, the record retrieve request comprising an alternate primary key value, which is based on a primary key value and a semi-unique key value, the database comprising a record structure comprising a first primary key field, a second primary key field, and a semi-unique key field, the first primary key field comprising a flag portion for which a first flag value is indicative of the first primary key field containing a primary key and a second flag value is indicative of the first primary key field containing an alternate primary key, the alternate primary key value having a portion thereof corresponding to the flag portion of the first primary key field set to the second flag value, the record for which the retrieve request is received comprising the primary key value in the second primary key field and the semi-unique key value in the semi-unique key field;
communicating the alternate primary key value to the database;
receiving from the database a plurality of records for which the respective flag portions of the first primary key field are set to the second flag value;
performing for each of the plurality of records received from the database:
generating a candidate primary key value, wherein generating the candidate primary key value comprises performing a logic operation on a semi-unique key field value and the alternate primary key value;
comparing the candidate primary key value with a second primary key field value; and
determining that one of the plurality of records corresponds to the record for which the retrieve request is received when the candidate primary key value matches the second primary key field value.

13. The method of claim 12, wherein the record retrieve request further comprises a secondary key value;
wherein generating the alternate primary key value comprises:
wherein the alternate primary key value is based on the primary key value, the semi-unique key value, and the secondary key value; and
wherein generating the candidate primary key value comprises:
performing a logic operation on the semi-unique key field value, the secondary key value, and the alternate primary key value.

14. The method of claim 13, wherein the logic operation is an exclusive or logic operation.

15. The method of claim 13, wherein the secondary key value comprises computer system identification information.

16. The method of claim 13, wherein the secondary key value comprises application identification information.

17. A system, comprising:
a processor; and
a memory coupled to the processor and comprising computer readable program code embodied in the memory that is executable by the processor to perform operations comprising:
receiving a record insert request for a database, the record insert request comprising a primary key value, a semi-unique key value, and a secondary key value, the database comprising a record structure comprising a first primary key field, a second primary key field, and a semi-unique key field, the first primary key field comprising a flag portion for which a first flag value is indicative of the first primary key field containing a primary key and a second flag value is indicative of the first primary key field containing an alternate primary key;
generating an alternate primary key value based on the primary key value, the semi-unique key value, and the secondary key value, the alternate primary key value having a portion thereof corresponding to the flag portion of the first primary key field set to the second flag value;
generating a record comprising the alternate primary key value in the first primary key field, the primary key value in the second primary key field, and the semi-unique key value in the semi-unique key field; and
communicating the record to the database.

18. The system of claim 17, wherein the record structure of the database further comprises a secondary key field;
wherein generating the record further comprises:
generating the record comprising the secondary key value in the secondary key field.

19. The system of claim 17, wherein generating the alternate primary key value comprises performing a logic operation on the primary key value, the semi-unique key value, and the secondary key value.

20. The system of claim 19, wherein the logic operation is an exclusive or logic operation.
